(19) United States
(12) Patent Application Publication
(10) Pub. No.: US 2020/0387404 A1
(43) Pub. Date: Dec. 10, 2020

(54) DEPLOYMENT OF VIRTUAL NODE CLUSTERS IN A MULTI-TENANT ENVIRONMENT

(71) Applicant: HEWLETT PACKARD ENTERPRISE DEVELOPMENT LP, Houston, TX (US)

(72) Inventors: Joel Baxter, San Carlos, CA (US); Swami Viswanathan, Morgan Hill, CA (US)

(21) Appl. No.: 16/431,471

(22) Filed: Jun. 4, 2019

(51) Int. Cl. G06F 9/50; G06F 9/455

(52) U.S. Cl. CPC G06F 9/5077; G06F 2009/45575; G06F 9/45558; G06F 9/5072

(57) ABSTRACT

Described herein are systems, methods, and software to manage the allocation of large-scale data processing clusters in a computing environment. In one implementation, a management system obtains a request for a new data processing cluster. In response to the request, the management system may determine a tenant associated with the request and determine computing systems available to the tenant. Once identified, the management system may select at least one of the computing systems to support the request and deploy one or more virtual nodes to the at least one computing system.

### TECHNICAL BACKGROUND

An increasing number of data-intensive distributed applications are being developed to serve various needs, such as processing very large data sets that are difficult to be processed by a single computer. Instead, clusters of computers are employed to distribute various tasks, such as organizing and accessing the data and performing related operations with respect to the data. Various large-scale processing applications and frameworks have been developed to interact with such large data sets, including Hive, HBase, Hadoop, Spark, among others.

At the same time, virtualization techniques have gained popularity and are now commonplace in data centers and other computing environments in which it is useful to increase the efficiency with which computing resources are used. In a virtualized environment, one or more virtual nodes are instantiated on an underlying physical computer and share the resources of the underlying computer. Accordingly, rather than implementing a single node per host computing system, multiple nodes may be deployed on a host to more efficiently use the processing resources of the computing system. These virtual nodes may include full operating system virtual machines, containers, such as Linux containers or Docker containers, jails, or other similar types of virtual containment nodes. However, although virtualization techniques provide increased efficiency within computing environments, difficulties often arise in managing the allocation of virtual nodes to computing systems in an environment. These difficulties are often compounded when an organization attempts to deploy virtual node clusters to various physical computing system configurations distributed across multiple physical locations.

### SUMMARY

The technology described herein enhances the deployment of clusters in a computing environment. In one implementation, a management system may identify a request to deploy a cluster in the computing environment, wherein the computing environment comprises multiple computing systems. The management system may further identify a tenant associated with the request and identify one or more of the computing systems available to the tenant. The method further includes selecting at least one computing system of the one or more systems to support the request and deploying one or more virtual nodes as part of the cluster in the at least one computing system.

### BRIEF DESCRIPTION OF THE DRAWINGS

FIG. 1 illustrates a computing environment to deploy clusters associated with multiple tenants according to an implementation.

FIG. 2 illustrates an operation of a management system to deploy clusters in a computing environment according to an implementation.

FIG. 3 illustrates a data structure to manage cluster deployment according to an implementation.

FIGS. 4A-4B illustrate an operational scenario of deploying a cluster in a computing environment according to an implementation.

FIG. 5 illustrates a management computing system according to an implementation.

### DETAILED DESCRIPTION

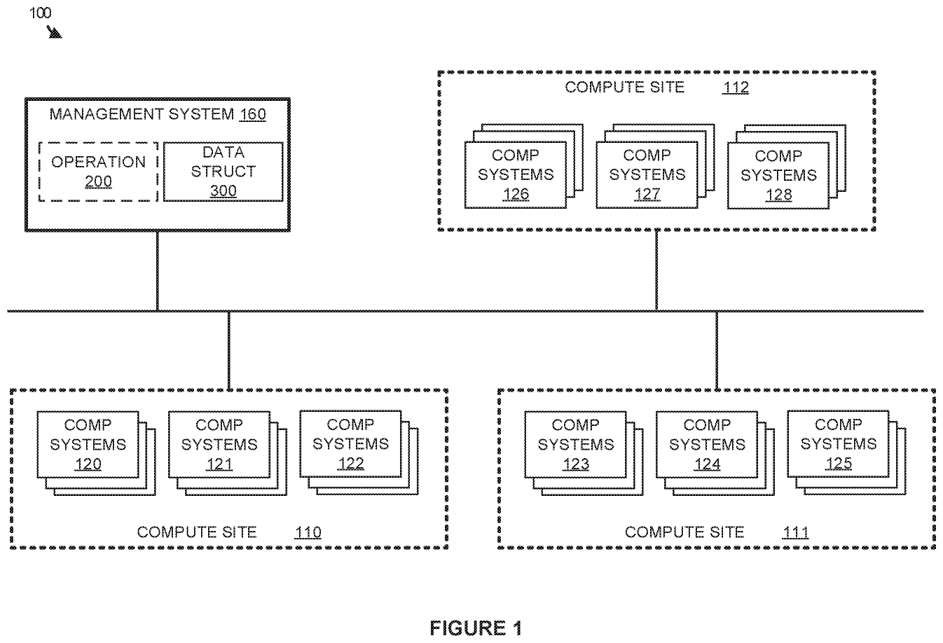

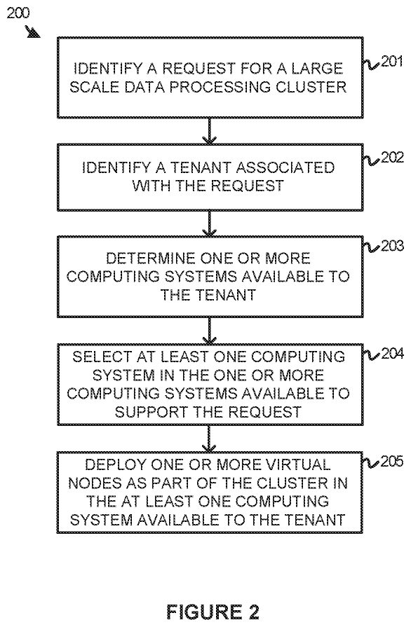

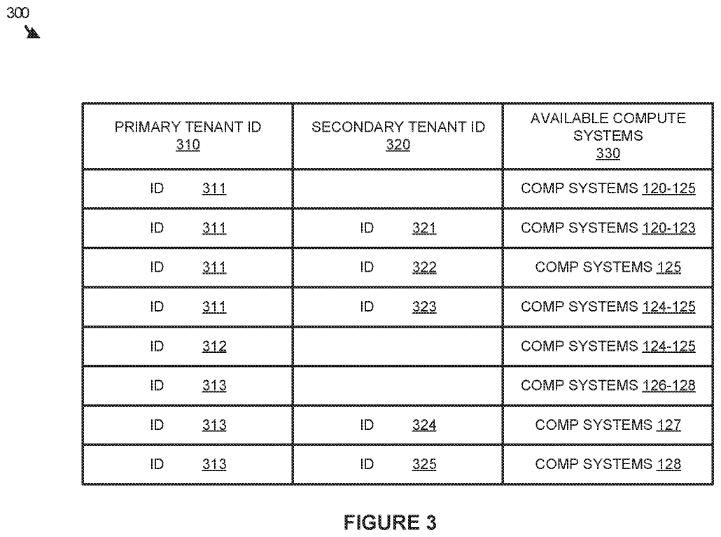

FIG. 1 illustrates a computing environment 100 to deploy clusters associated with multiple tenants according to an implementation. Computing environment 100 includes management system 160 and compute sites 110-112, wherein compute sites 110-112 include computing systems 120-128. Computing sites 110-112 may each correspond to a different geographic location, such as data center location, office location, or some other different location. Computing systems 120-128 may comprise server computing systems, desktop computing systems, or some other type of computing systems. Management system 160 provides operation 200 that is further described in FIG. 2. Management system 160 further includes data structure 300 that is further described in FIG. 3 and may be used by operation 200 to identify computing systems to support clusters in computing environment 100.

In operation, computing environment 100 is deployed to provide a platform for data processing clusters. These data processing clusters may each comprise virtual nodes that process data from one or more storage repositories in parallel. The data processing operations of the virtual nodes may comprise MapReduce operations, data search operations, or some other similar operations on data sets within the one or more storage repositories. In some examples, the storage repositories may be stored on the same computing systems 120-128 as the virtual nodes, however, the storage repositories may be located on one or more other computing systems, such as server computers, desktop computers, or some other computing system. The storage repositories may each represent data stored as a distributed file system, as object storage, or as some other data storage structure.

In deploying the clusters to computing systems 120-128, management system 160 may be responsible for allocating computing resources to the clusters, and deploying the virtual nodes required for the clusters. The virtual nodes may comprise full operating system virtual machines or containers. The containers may comprise Linux containers, Docker containers, and other similar namespace-based containers. Rather than requiring a separate operating system, which is required for virtual machines, containers may share resources from the host computing system, wherein the resources may include kernel resources from the host operating system and may further include repositories and other approved resources that can be shared with other containers or processes executing on the host. However, although resources may be shared between the containers on a host, the containers are provisioned to have private access to the operating system via their own identifier space, file system structure, and network interfaces. The operating system may also be responsible for allocating processing resources, memory resources, network resources, and other similar resources to the containerized endpoint.

To allocate the computing resources to the virtual nodes, management system 160 may determine host computing systems for the virtual nodes based on the tenant requesting the cluster deployment. In some implementations, computing environment 100 may represent an environment that provides host computing systems for clusters belonging to multiple tenants. These tenants may comprise multiple organizations, such as companies, government entities, or some other organization, and/or may comprise a subdivision of an organization, such as a sales department, human resources department, or some other subdivision of an organization. When a request for a cluster is generated by a tenant, management system 160 may identify the tenant associated with the request and determine one or more of computing systems 120-128 that are available to that tenant. The computing systems that are available to each of the tenants may be determined based on the physical location of the computing systems, the computing resources (processor, memory, storage, graphics processor, networking, and the like) of the computing systems, or some other factor associated with the individual tenants. In some implementations, each of the tenants may define physical resource requirements, wherein the resource requirements may include the computing resources required by the tenant, the locations of the computing systems required by the tenant, or some other requirement information for a tenant. For example, a first tenant of computing environment 100 may be allocated computing systems 120-122 of compute site 110 and computing systems 126-127 of compute site 112. These computing systems may be identified as being available for the tenant based on the locations of the compute sites as well as the computing hardware of the computing systems at the compute sites. Thus, although computing systems 128 reside in compute site 112 with other computing systems 126-127, computing systems 128 may not be allocated to the tenant because the hardware configuration fails to meet the requirements of the tenant. In some examples, the computing systems that are available to a tenant may be dynamic based on the physical configuration of computing environment 100. As computing systems are added or removed from the system, management system 160 may identify the changes and determine changes to the available computing systems for each of the tenants. Thus, if a new compute site was added, management system 160 may query the new computing systems to determine the physical configurations of the new computing systems. The computing systems may then be associated with any corresponding tenant of computing environment 100. In some examples, the computing systems available to each of the tenants may be maintained in one or more data structures, such as data structure 300 further described in FIG. 3.

In some examples, management system 160 may maintain information about tiers of tenants, where child tenants (or subtenants) may exist within each tenant of a computing environment 100. For example, a tenant may comprise a corporation, and a subtenant or child tenant may comprise a division in the corporation (such as a legal or advertising department). The resources allocated to parent tenant may be based on a quality of service selected by the parent tenant, based on the different data processing operations or software applications required by the parent tenant, based on pricing tiers determined by the parent tenant, or based on other similar factors. Once the parent tenants have been established, subtenants may be defined either by an administrator associated with the tenant or an administrator associated with computing environment 100. For example, when an organization joins computing environment 100, the organization may be allocated first physical resources for the environment. Once allocated, the organization may subdivide the allocated resources to smaller groups within the organization, wherein the subdivision may be based on the physical computing resources required by the group, the types of data processing applications to be executed by the group, the quality of service required for the group, or some other factor. As a result, although a tenant may be provided with access to one or more computing systems in computing environment 100, management system 160 may ensure that only a portion of the one or more computing systems available are given to a specific cluster instantiated by a given tenant based on the tier associated with the given cluster.

FIG. 2 illustrates an operation 200 of a management system to deploy clusters in a computing environment according to an implementation. The processes of operation 200 are referenced parenthetically in the paragraphs that follow with reference to systems and elements of computing environment 100 of FIG. 1.

As depicted, operation 200 of management system 160 identifies (201) a request for a data processing cluster in computing environment 100, wherein the computing environment comprises a plurality of computing systems. The request for the data processing cluster may request the deployment of virtual nodes capable of processing data from one or more storage repositories. The storage repositories may comprise data stored in a distributed file system, object storage, or some other storage repository that can be stored over one or more physical systems. In response to the request, management system 160 may identify (202) a tenant associated with the request from a plurality of tenants of the computing environment. Once the tenant is identified, management system 160 may determine one or more computing systems available to the tenant from the plurality of computing systems in computing environment 100. In some implementations, computing environment 100 may be shared by a plurality of tenants that may comprise organizations, divisions of one or more organizations, or some other. To provide each of the tenants with processing resources to support the requested clusters, each of the tenants may define physical resource requirements, computing system location requirements, or other requirements for the clusters to be deployed in computing environment 100. In at least one implementation, when a tenant joins computing environment 100, the tenant may define the requirements of the tenant, such as the type of computing system required, the processor cores required, the memory required, the storage required, the location of the computing systems, or some other requirement. Once defined, management system 160 may store the information as a service level agreement for the tenant and identify corresponding computing systems of computing systems 120-128 that satisfy the requirements of the tenant. In some implementations, management system 160 may maintain at least one data structure, such as data structure 300, that can be used to associate tenants with computing systems that match the tenant requirements.

Once the computing systems are identified for the tenant, management system 160 further selects (204) at least one computing system of the one or more computing systems to support the request. In some implementations, the computing system may be selected based on the data processing application (version and type) requested, the resources requested for the specific cluster, or some other configuration attribute related to the request. In at least some configurations, different computing systems may be configured with various physical computing resources. For example, computing systems 120 may be configured with first resources that fail to include a dedicated graphics processing unit (GPU), however, computing systems 121 may be configured with second resources that include dedicated GPUs that can be accessed by the applications operating on computing systems 121. As a result, based on whether an application required the use of a dedicated GPU, management system 160 may select at least one computing system from computing systems 120 or computing systems 121 to support the cluster request.

In addition to or in place of identifying the attributes associated with the clustered application, management system 160 may further consider accommodation information associated with the available computing systems to the tenant. The accommodation data may include the quantity of virtual nodes that are being executed on each of the computing systems, the quantity of resources available on each of the computing systems, the latency or throughput to the required data repository for the cluster, or some other accommodation factor. The accommodation information may be reported from the computing systems periodically, may be provided in response to a request by the management system, or at any other interval. In at least one example, management system 160 may determine an estimated data processing rate for the cluster based on the accommodation factors. The estimated data processing rate may be determined using an algorithm, one or more data structures, previous cluster operations or historical data, or some other operation, including combinations thereof. As a result, if multiple computing systems were identified as associated with a tenant, a computing system may be selected based on the ability of the computing system to accommodate the cluster.

In some examples, in addition to the accommodation information for the computing systems, management system 160 may further consider a quality of service associated with the tenant. As an example, each of the tenants may be associated with a minimum quality of service or minimum amount of physical resources but may be allocated additional resources or enhanced processing resources when the resources are available in computing environment 100. For example, computing systems 120-121 may each comprise a different processor, wherein computing systems 120 may provide faster processing than computing systems 121. Additionally, a tenant may require minimum processing resources that correspond to computing systems 121. When the tenant requests a cluster, management system 160 may determine accommodation data associated with computing systems 120-121. If the accommodation data indicates that the cluster can be deployed on computing systems 120, then the cluster may be deployed on computing systems 120 over computing systems 121. For example, if the cluster can be deployed on computing systems 120 without interfering with the minimum quality of service of other clusters that are also executing on the computing systems 120, then the cluster may be deployed to computing systems 120. However, if the accommodation data indicates that other clusters may not receive an adequate quality of service, then the cluster may be deployed in computing systems 121 that provide the minimum quality of service. Although a cluster may be initially deployed in a first set of one or more computing systems, it should be understood that the application may migrate to a second set of one or more other computing systems. As an example, if additional clusters are requested from tenants associated with a better quality of service, the original cluster may be migrated to another set of one or more computing systems to provide the other tenant with the required quality of service.

In some implementations, the availability of computing systems may be transparent to the various tenants of computing environment 100. In particular, rather than providing identifying details (e.g. internet protocol addresses, computing system names, and the like) for the computing systems available to the tenant, the tenant may instead provide the physical requirements of the computing systems for the clusters and deploy the clusters without information about the corresponding host computing system. In some implementations, in addition to or in place of providing the physical resource requirements, the tenants may provide information about the data processing software that will be used in the cluster or a quality of service associated with the clusters operating that software. From the specifications of the tenant, computing systems may be identified in computing environment 100 that meet the defined criteria. The identified computing systems may be updated based on computing systems being added or removed from the system. In some examples, the computing systems available to a tenant may be identified when the cluster is requested, however, it should be understood that management system 160 may maintain one or more data structures that associate available computing systems with the corresponding tenants.

After the at least one computing system is identified to support the cluster request, management system 160 further deploys (205) one or more virtual nodes as part of the cluster in the at least one computing system. In some implementations, the deployment may include distributing images of the data processing application to the corresponding computing systems, configuring the virtual nodes with IP address information, port information, or some other addressing information for the cluster, allocating physical resources to each of the virtual nodes, configuring a domain name service (DNS), or providing some other operation related to the deployment of the virtual nodes.

In some examples, in addition to managing the allocation of virtual nodes in computing environment 100, management system 160 may further maintain information related to the different types of data processing applications available to each of the tenants. The data processing applications may be made available to the tenants based on software licenses of each of the tenants, based on a quality of service associated with each of the tenants, or based on some other factor. As a result, while a first tenant may request a distributed data processing application from a first software provider, a second tenant may be unable to request the same application. In at least one implementation, cluster configuration attributes (e.g., the cluster type, number of virtual nodes, processing cores requested, and the like) may be identified from a tenant when the cluster is requested and used in determining which of the host systems should be allocated to support the request.

FIG. 3 illustrates a data structure 300 to manage cluster deployment according to an implementation. Data structure 300 is representative of data structure that can be maintained by management system 160 of FIG. 1. Data structure 300 includes columns for primary tenant identifiers (IDs) 310, secondary tenant IDs 320, and available computing systems 330. Primary tenant IDs 310 includes IDs 311-313 and secondary tenant IDs 320 includes IDs 321-325. Although demonstrated as a table in the example of FIG. 3, a management system may use one or more trees linked lists, graphs, tables, or other data structures to maintain the availability information for computing nodes in the computing environment.

Primary tenant IDs 310 are representative of a first tier of tenants for computing environment 100, wherein the first tier may comprise organizations or subsets of an organization. For example, computing environment 100 may provide computing resources to a plurality of organizations where each organization represents a tenant of the environment with different resource requirements. Secondary tenant IDs 311 are representative of a second tier or child tier of the primary tenants. Returning to the example of multiple organizations sharing the computing resources of computing environment 100, secondary IDs 311 may be representative of groups within a particular organization, such as accounting, marketing, legal, and the like. These secondary tenant groups may be provided any amount of resources up to and including the resources that were allocated to the corresponding primary tenant. In some implementations, the secondary tenant may be allocated resources by an administrator associated with the corresponding primary tenant. For example, an administrator associated with primary tenant ID 311 may allocate compute nodes from compute nodes 120-125. The computing nodes may be allocated based on resources required by the secondary tenant, may be allocated based on a quality of service required by the secondary tenant, or may be allocated based on some other factor.

After generating the data structure 300, the various tenants may generate requests to implement clusters in the computing environment. In providing the requests, each of the tenants may provide credentials associated with their corresponding ID or IDs. The credentials may comprise usernames, passwords, keys, or some other credential capable of identifying the tenant with the request. For example, when a request is provided with a tenant ID 322, the management system may identify that compute node 125 is capable of supporting the request. Once identified, the cluster may be deployed to computing node 125, wherein the cluster may be deployed as one or more virtual nodes in the computing system.

In some implementations, in addition to or in place of data structure 300, the management system may maintain one or more data structures that correspond to requirements of the various tenants (primary IDs) and sub-tenants (secondary IDs). The requirements may include the physical resource requirements, the location requirements, or some other similar requirement. The management system may use the requirement information to identify the corresponding computing systems available to teach of the tenants. In some examples, this may include populating data structure 300 with information about available computing systems, however, it should be understood that the computing systems may be identified in response to the request from a particular tenant, wherein the management system may identify computing systems that satisfy the requirements of the requesting tenant.

Although demonstrated in the example of FIG. 3 with two tenant tiers, it should be understood that a computing environment may implement any number of tenant tiers. Each of the tenants in a lower tier (children tenants) may be allocated a subset of the resources that are provided to the parent tenant. Thus, if the parent tenant were capable of accessing three computing systems, the child tenant may be capable of accessing one or more of the three computing systems.

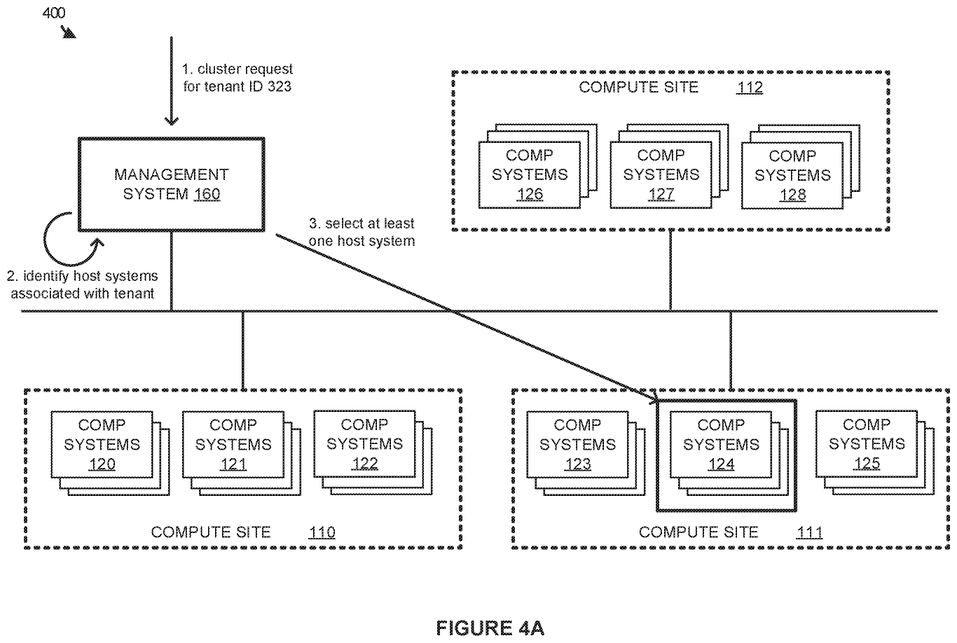

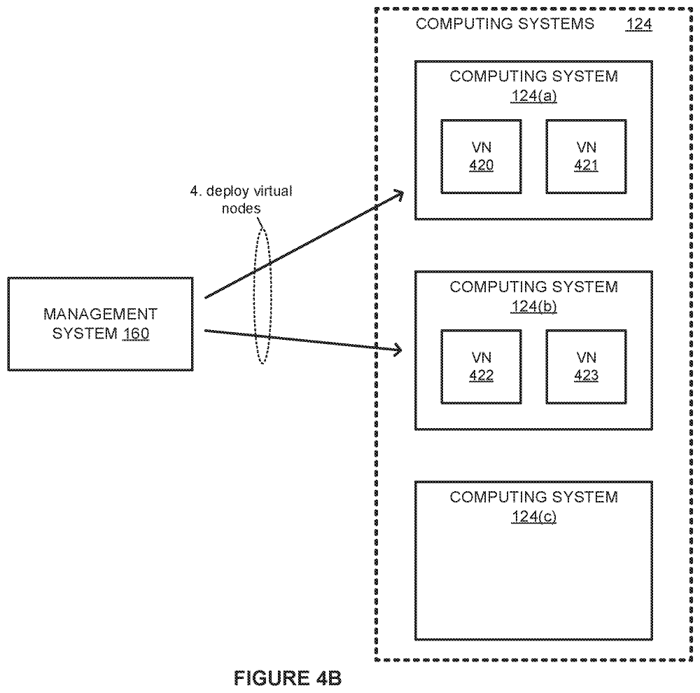

FIGS. 4A-4B illustrate an operational scenario of deploying a cluster in a computing environment according to an implementation. FIGS. 4A and 4B include systems and elements of computing environment 100 of FIG. 1. FIG. 4B includes management system 160, computing systems 124(a)-124(c), and virtual nodes 420-423 that are representative of virtual nodes initiated as part of a cluster request. The operations of management system 160 use data structure 300 of FIG. 3 in determining computing systems associated with tenants, however, other types of data structures may be consulted to identify computing systems associated with tenants.

Referring to FIG. 4A, management system 160 obtains, at step 1, a request for a cluster from tenant associated with tenant ID 323. The request may be provided from a console device, such as a laptop, desktop, phone, tablet, or some other device and may be provided via a browser on the client device or a dedicated application associated with computing environment 100. In some implementations, the request may provide credentials that can be used to identify and verify the tenant requesting the cluster. These credentials may comprise a username, password, key, or some other type of credential to identify the tenant. In response to the request, management system 160 identifies, at step 2, host systems associated with the tenant.

In at least one implementation, each of the tenants may be associated with requirements of the tenant, wherein the requirements may comprise physical computing requirements of the tenant, such as processor requirements, memory requirements, local storage requirements, networking requirements, or some other physical computing requirement. The requirements may further comprise operating system requirements, security requirements, location requirements for the computing systems, or some other similar requirements. Based on the requirements defined by the tenant or an administrator associated with the tenant, management system 160 may determine computing systems that qualify for the tenant. Accordingly, when a request is obtained from a tenant with tenant ID 322, which corresponds to a sub-tenant of the tenant of tenant ID 311, management system 160 may determine that computing systems 124-125 are available to the tenant.

Once the systems are identified that are associated with the tenant, management system 160 further selects, at step 3, at least one computing system in computing systems 124-125 to support the request. The at least one computing system may be selected based on availability information for computing systems 124-125, may be determined based on the type of cluster selected by the user (e.g., the type or version of the software selected for the cluster), the storage repository associated with the cluster for processing, a quality of service requirement, or some other factor. In at least one example, management system 160 may obtain availability information for each computing system of computing systems 124-125 and select at least one computing system based on the availability information. This availability information may include processing resource availability, communication interface availability (e.g., throughput, latency, etc.), and the like. Thus, if a first computing system were executing a larger quantity of virtual nodes over a second computing system, management system 160 may select the second computing system as it may provide a better quality of service to the executing cluster.

Turning to FIG. 4B, management system 160 selects computing systems 124(a) and 124(b) of computing systems 124-125 to implement the requested cluster. Once selected, virtual nodes 420-423 are deployed, at step 4, on computing systems 124(a) and 124(b) to support the cluster request. The deployment operation may include providing an image for the corresponding cluster (e.g., container image, virtual machine image, or some other image), allocating resources to support the various virtual nodes, configuring IP addresses and ports for the virtual nodes to communicate, or providing some other operation to initiate execution of the virtual nodes.

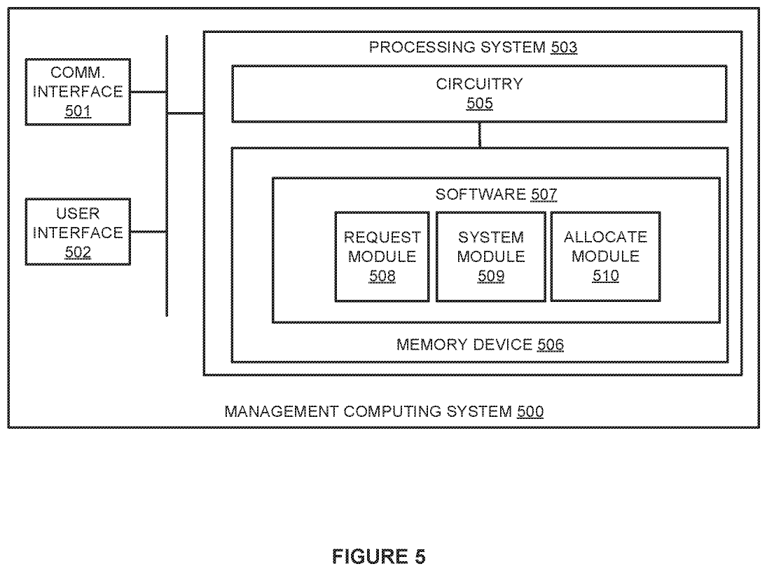

FIG. 5 illustrates a management computing system 500 according to an implementation. Computing system 500 is representative of any computing system or systems with which the various operational architectures, processes, scenarios, and sequences disclosed herein for a management system may be implemented. Computing system 500 is an example management system that could be used in initiating and configuring clusters on host systems as described herein. Computing system 500 comprises communication interface 501, user interface 502, and processing system 503. Processing system 503 is linked to communication interface 501 and user interface 502. Processing system 503 includes processing circuitry 505 and memory device 506 that stores operating software 507. Computing system 500 may include other well-known components such as a battery and enclosure that are not shown for clarity.

Communication interface 501 comprises components that communicate over communication links, such as network cards, ports, radio frequency (RF), processing circuitry and software, or some other communication devices. Communication interface 501 may be configured to communicate over metallic, wireless, or optical links. Communication interface 501 may be configured to use Time Division Multiplex (TDM), Internet Protocol (IP), Ethernet, optical networking, wireless protocols, communication signaling, or some other communication format—including combinations thereof. In at least one implementation, communication interface 501 may be used to communicate with one or more hosts of a computing environment, wherein the hosts execute virtual nodes to provide various processing operations.

User interface 502 comprises components that interact with a user to receive user inputs and to present media and/or information. User interface 502 may include a speaker, microphone, buttons, lights, display screen, touch screen, touch pad, scroll wheel, communication port, or some other user input/output apparatus—including combinations thereof. User interface 502 may be omitted in some examples.

Processing circuitry 505 comprises microprocessor and other circuitry that retrieves and executes operating software 507 from memory device 506. Memory device 506 may include volatile and nonvolatile, removable and non-removable media implemented in any method or technology for storage of information, such as computer readable instructions, data structures, program modules, or other data. Memory device 506 may be implemented as a single storage device, but may also be implemented across multiple storage devices or sub-systems. Memory device 506 may comprise additional elements, such as a controller to read operating software 507. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing circuitry 505 is typically mounted on a circuit board that may also hold memory device 506 and portions of communication interface 501 and user interface 502. Operating software 507 comprises computer programs, firmware, or some other form of machine-readable program instructions. Operating software 507 includes request module 508, system module 509, and allocate module 510, although any number of software modules may provide a similar operation. Operating software 507 may further include an operating system, utilities, drivers, network interfaces, applications, or some other type of software. When executed by processing circuitry 505, operating software 507 directs processing system 503 to operate computing system 500 as described herein.

In one implementation, request module 508 directs processing system 503 to obtain or identify a request for a cluster to be deployed in a computing environment managed by computing system 500. In response to the request, system module 509 directs processing system 503 to identify a tenant associated with the request and determine one or more computing systems in the computing environment that correspond to the tenant. In some implementations, a computing environment may permit a plurality of tenants to deploy clusters across computing systems of the environment. In the environment, each of the tenants may be allocated different physical resources based on requirements of the individual tenant, wherein the tenant may define the computing requirements of the cluster. For example, when a tenant joins the computing environment, the tenant may provide requirements for the clusters that are deployed in the environment, wherein the requirements may comprise quality of service requirements, hardware or physical resource requirements, location requirements, software requirements, or some other requirement for the clusters. Once defined, system module 509 may determine one or more computing systems in the computing environment that correspond to the requirements of the tenant.

After identifying the computing systems that are available to the tenant, allocate module 510 directs processing system 503 to identify at least one computing system in the available computing systems to support the request. In identifying the at least one computing system, allocate module 510 may consider the type of data processing software to be deployed, the version of the data processing software, the number of virtual nodes requested, or some other factor related to the request. Further, in addition to or in place of the information from the request, allocate module 510 may further use availability factors associated with the computing systems to determine which of the computing systems would provide the best quality of service for the cluster. For example, if a tenant were associated with three computing systems and a first computing system included a greater amount of bandwidth to obtain data from a storage repository, the first computing system may be selected for the virtual nodes over the other computing systems. Once selected, allocate module 510 directs processing system 503 to deploy one or more virtual nodes in the at least one selected computing system, wherein the deployment may include allocating resources, providing images for the application, configuring communication parameters, or providing some other similar operation to initiate execution of the cluster.

In some implementations, the tenant structure of the computing environment may be tiered, such that a first tenant may be the parent of one or more child tenants. The parent tenant may be used to allocate resources to each of the child tenants. For example, when registering with the computing environment, a parent tenant may be associated with first resources and first host computing systems. From the available resources, the parent may define resources to be made available to one or more child tenants, such as groups associated with the tenant. The resources may include hardware requirements for the child tenants, location requirements for the child tenants, storage repositories to be made available to the child tenants, or some other requirement of child tenants. In some examples, in addition to limiting the access to the computing systems in the environment, the management system may also limit the types of clusters available to each of the tenants. These limitations may include limits in the resources allocated to the clusters, the data processing applications for the clusters, versions of the data processing clusters, or some other limitation to the requested clusters. The limitations may be based on a quality of service associated with the tenant, software licenses of the tenant, or some other factor.

Returning to the elements of FIG. 1, computing systems 120-128 may each comprise communication interfaces, network interfaces, processing systems, microprocessors, storage systems, storage media, or some other processing devices or software systems. Examples of computing systems 120-128 can include software such as an operating system, logs, databases, utilities, drivers, networking software, and other software stored on a computer-readable medium. Computing systems 120-128 may comprise, in some examples, one or more server computing systems, desktop computing systems, laptop computing systems, or any other computing system, including combinations thereof. In some implementations, computing systems 120-128 may comprise virtual machines that comprise abstracted physical computing elements and an operating system capable of providing a platform for the virtual nodes of the clusters.

Management system 160 may comprise one or more communication interfaces, network interfaces, processing systems, microprocessors, storage systems, storage media, or some other processing devices or software systems, and can be distributed among multiple devices. Examples of management system 160 can include software such as an operating system, logs, databases, utilities, drivers, networking software, and other software stored on a computer-readable medium. Management system 160 may comprise one or more serving computers, desktop computers, laptop computers, or some other type of computing systems.

Communication between computing systems 120-128 and management system 160 may use metal, glass, optical, air, space, or some other material as the transport media. Communication between computing systems 120-128 and management system 160 may use various communication protocols, such as Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format, including combinations, improvements, or variations thereof. Communication between computing systems 120-128 and management system 160 may be a direct link or can include intermediate networks, systems, or devices, and can include a logical network link transported over multiple physical links.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
identifying a request for a large-scale data processing cluster in a computing environment, the computing environment comprising a plurality of computing systems;
identifying a tenant associated with the request from a plurality of tenants of the computing environment;
determining one or more computing systems available to the tenant from the plurality of computing systems;
selecting at least one computing system of the one or more computing systems to support the request; and
deploying one or more virtual nodes as part of the large-scale data processing cluster in the at least one computing system.

2. The method of claim 1, wherein determining the one or more computing systems available to the tenant from the plurality of computing systems comprises:
identifying physical resources available on the plurality of computing systems;
identifying physical resource requirements of the tenant;
selecting the one or more computing systems with physical resources that satisfy the physical resource requirements of the tenant.

3. The method of claim 1, wherein selecting the at least one computing system of the one or more computing systems to support the request comprises:
identifying accommodation information associated with the one or more computing systems, wherein the accommodation information comprises at least an estimated data processing rate for the large-scale data processing cluster;
selecting the at least one computing system based on the accommodation information.

4. The method of claim 1, wherein determining the one or more computing systems available to the tenant from the plurality of computing systems comprises:
identifying physical locations associated with the plurality of computing systems;
identifying location requirements associated with computing resources for the tenant;
selecting the one or more computing systems with physical locations that satisfy the location requirements associated with the tenant.

5. The method of claim 1 further comprising:
identifying one or more cluster configuration attributes associated with the cluster request;
wherein selecting the at least one computing system of the one or more computing systems to support the request comprises selecting the at least one computing system based on the cluster configuration attributes.

6. The method of claim 1, wherein identifying the tenant associated with the request from a plurality of tenants of the computing environment comprises identifying the tenant based on credentials provided in association with the request.

7. The method of claim 1, wherein the one or more virtual nodes comprise one or more containers or virtual machines.

8. The method of claim 1 further comprising:
obtaining resource requirements associated with each tenant in the plurality of tenants; and
wherein determining the one or more computing systems available to the tenant from the plurality of computing systems comprises determining the one or more computing systems available to the tenant from the plurality of computing systems based on the resource requirements associated with the tenant.

9. A computing apparatus comprising:
one or more non-transitory computer readable storage media;
a processing system operatively coupled to the one or more non-transitory computer readable storage media; and
program instructions stored on the one or more non-transitory computer readable storage media that, when executed by the processing system, direct the processing system to:
identify a request for a large-scale data processing cluster in a computing environment, the computing environment comprising a plurality of computing systems;
identify a tenant associated with the request from a plurality of tenants of the computing environment;
determine one or more computing systems available to the tenant from the plurality of computing systems;
select at least one computing system of the one or more computing systems to support the request; and
deploy one or more virtual nodes as part of the large-scale data processing cluster in the at least one computing system.

10. The computing apparatus of claim 9, wherein determining the one or more computing systems available to the tenant from the plurality of computing systems comprises:
identifying physical resources available on the plurality of computing systems;
identifying physical resource requirements of the tenant;
selecting the one or more computing systems with physical resources that satisfy the physical resource requirements of the tenant.

11. The computing apparatus of claim 9, wherein selecting the at least one computing system of the one or more computing systems to support the request comprises:
identifying accommodation information associated with the one or more computing systems, wherein the accommodation information comprises at least an estimated data processing rate for the large-scale data processing cluster; and
selecting the at least one computing system based on the accommodation information.

12. The computing apparatus of claim 9, wherein determining the one or more computing systems available to the tenant from the plurality of computing systems comprises:
identifying physical locations associated with the plurality of computing systems;
identifying location requirements associated with computing resources for the tenant;
selecting the one or more computing systems with physical locations that satisfy the location requirements associated with the tenant.

13. The computing apparatus of claim 9, wherein the program instructions further direct the processing system to:
identify one or more cluster configuration attributes associated with the cluster request;
wherein selecting the at least one computing system of the one or more computing systems to support the request comprises selecting the at least one computing system based on the cluster configuration attributes.

14. The computing apparatus of claim 9, wherein identifying the tenant associated with the request from a plurality of tenants of the computing environment comprises identifying the tenant based on credentials provided in association with the request.

15. The computing apparatus of claim 9, wherein the one or more virtual nodes comprise one or more containers or virtual machines.

16. The computing apparatus of claim 9, wherein the program instructions direct the processing system to:
obtain resource requirements associated with each tenant in the plurality of tenants; and
wherein determining the one or more computing systems available to the tenant from the plurality of computing systems comprises determining the one or more computing systems available to the tenant from the plurality of computing systems based on the resource requirements associated with the tenant.

17. A computing environment comprising:
a plurality of computing systems;
a management system configured to:
identify a request for a large-scale data processing cluster in the computing environment;
identify a tenant associated with the request from a plurality of tenants of the computing environment;
determine one or more computing systems available to the tenant from the plurality of computing systems;
select at least one computing system of the one or more computing systems to support the request; and
deploy one or more virtual nodes as part of the large-scale data processing cluster in the at least one computing system.

18. The computing environment of claim 17, wherein determining the one or more computing systems available to the tenant from the plurality of computing systems comprises:
identifying physical resources available on the plurality of computing systems;
identifying physical resource requirements of the tenant;
selecting the one or more computing systems with physical resources that satisfy the physical resource requirements of the tenant.

19. The computing environment of claim 17, wherein determining the one or more computing systems available to the tenant from the plurality of computing systems comprises:
identifying physical locations associated with the plurality of computing systems;
identifying location requirements associated with computing resources for the tenant;
selecting the one or more computing systems with physical locations that satisfy the location requirements associated with the tenant.

20. The computing environment of claim 17, wherein the one or more virtual nodes comprise one or more containers or virtual machines.
